(19) United States
(12) Patent Application Publication
(10) Pub. No.: US 2005/0128446 A1
(43) Pub. Date: Jun. 16, 2005

(54) Exposure apparatus and device manufacturing method

(75) Inventor: Yoshikazu Miyajima, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/006,759

(22) Filed: Dec. 8, 2004

(30) Foreign Application Priority Data
Dec. 11, 2003 (JP) 2003-412776

(51) Int. Cl. G03B 27/52

(52) U.S. Cl. 355/30; 355/67

(57) ABSTRACT

An exposure apparatus for projecting a pattern of an original onto a substrate using illumination light, includes a transfer system, having a channel, to transfer heat via the channel, and an optical element, upon which the illumination light enters, and in which a space, in which said channel is provided, is formed.

### BACKGROUND OF THE INVENTION

The present invention relates to an exposure apparatus that exposes a substrate, i.e., an object to be exposed, such as a semiconductor wafer and a glass plate for a liquid crystal display (“LCD”). The present invention is suitable, for example, for an exposure apparatus that uses the ultraviolet (“UV”) or extreme ultraviolet (“EUV”) light as an exposure light. The present invention is also relates to a device manufacturing method using this exposure apparatus.

A reduction projection exposure apparatus has been conventionally employed which uses a projection optical system to project a circuit pattern formed on a mask (or a reticle) onto a wafer, etc to transfer the circuit pattern, in manufacturing such a fine semiconductor device as a semiconductor memory and a logic circuit in photolithography technology.

The minimum critical dimension (“CD”) to be transferred by the projection exposure apparatus or resolution is proportionate to a wavelength of light used for exposure, and inversely proportionate to the numerical aperture (“NA”) of the projection optical system. The shorter the wavelength is, the better the resolution is. Therefore, recent demands for finer processing to semiconductor devices have promoted use of a shorter wavelength of the UV light from an ultra-high pressure mercury lamp (i-line with a wavelength of about 365 nm) to KrF excimer laser (with a wavelength of about 248 nm) and ArF excimer laser (with a wavelength of about 193 nm.)

The lithography using the UV light, however, has the limit to satisfy the rapidly progressing fine processing of semiconductor devices. Accordingly, there has been developed a reduction projection optical system using the EUV light with a wavelength, such as about 10 nm to 15 nm, shorter than that of the UV light, (which exposure apparatus is referred to as an “EUV exposure apparatus” hereinafter) for efficient transfers of very fine circuit patterns smaller than 0.1 μm.

The light absorption in a material remarkably increases as the wavelength of the exposure light becomes shorter, and it is difficult to use a refraction element or lens for visible light and ultraviolet light. In addition, no glass material exists in a wavelength range of the EUV light, and a reflection-type or catoptric optical system uses only a reflective element or mirror, such as Mo—Si multilayer coating mirror.

The mirror does not completely reflect the exposure light, but the reflectance per mirror surface is about 70%. The remaining exposure light of about 30% is absorbed in the mirror's base or mirror's primary ingredient, which usually uses glass. In order to serve as a reflective surface, a surface of the mirror's base is mirror-polished, and a reflective coating is formed on the polished base. The absorbed exposure light causes residual heat, and the temperature rise by 10 to 20° C. in the exposure light reflecting area of the mirror 120 as shown in FIG. 12. Then, even if the mirror base is made of a material having a very small coefficient of thermal expansion, such as low thermal expansion glass, the reflective surface deforms by 50 to 100 nm at the mirror base the mirror's periphery.

Since the surface shape precision required for the mirror in the exposure apparatus is between 0.1 nm to about several nanometers, it becomes difficult to guarantee the mirror's precision for the reflective surface that greatly deforms as discussed above. As a result, various problems happen in the exposure apparatus, such as deteriorated optical performance, imaging performance and light intensity, the non-uniform light intensity distribution, and the insufficient condensing performance, as well as the lowered exposure precision and throughput.

Accordingly, prior art proposes various mirror cooling methods for cooling a mirror. For example, Japanese Patent Application, Publication No. 05-205998 cools a mirror by providing a groove in the mirror's base and a cooling pipe that contacts the groove for circulating coolant (such as cooling water).

Since the cooling pipe contacts the mirror according to Japanese Patent Application, Publication No. 05-205998, the vibrations associated with circulations of the coolant in the cooling pipe transmit to the mirror. Due to the vibrating mirror (s), a pattern on an original form cannot be precisely projected onto a substrate, the exposure precision deteriorates, and the semiconductor devices manufactured from the substrate become defective.

### BRIEF SUMMARY OF THE INVENTION

With the foregoing in mind, it is an exemplary object of the present invention to provide an exposure apparatus and a device manufacturing method using the exposure apparatus, which perform the temperature control of an optical element so as to improve the exposure precision.

An exposure apparatus according to one aspect of the present invention for projecting a pattern of an original onto a substrate using illumination light, said exposure apparatus includes a transfer system, having a channel, to transfer heat via said channel, and an optical element, upon which the illumination light enters, and in which a space, in which said channel is provided, is formed.

The space may include at least one of a through-hole and a concave portion. Said space and said channel may be located outside a region through which the illumination light passes. Said channel may be spaced from said optical element in said space. Said transfer system may transfer a temperature-controlled medium through said channel. Said transfer system may include a radiation plate provided in said space.

Said space may be located at a first surface, upon which the illumination light enters, of said optical element. Said space may be located at a second surface opposite to the first surface. Said space may be located at a surface opposite to a surface, upon which the illumination light enters, of said optical element. Said space may be located at a side surface of said optical element.

Said optical element may be one of a mirror and a lens. An exposure apparatus may further include a vacuum system for creating a vacuum atmosphere in which said optical element is located. An exposure apparatus may further include a light source for emitting EUV light as the illumination light. Said optical element may be an element of one of an optical system to direct the light from a light source to the original, and an optical system to direct the light from the original to the substrate.

Said transfer system may include a tube which passes through said space, and a circulation system to circulate temperature controlled medium via said tube. Said transfer system may include a first temperature detecting unit to detect temperature of said optical element, a second temperature detecting unit to detect temperature of the medium, and a temperature control unit to control temperature of the medium based on detection results by said first and second temperature detecting units.

A device manufacturing method according to another aspect of the present invention includes steps of transferring a pattern of an original to a substrate using an exposure apparatus, and developing the substrate to which the pattern has been transferred.

Other objects and further features of the present invention will become readily apparent from the following description of the preferred embodiments with reference to accompanying drawings.

### BRIEF DESCRIPTION OF THE DRAWINGS

FIG. 1 shows a schematic internal structure of an exposure apparatus that uses an optical element according to the present invention.

FIGS. 2A and 2B show a structure of an illumination light source in the exposure apparatus shown in FIG. 1, wherein FIG. 2A shows that a laser excites and emits the EUV light, and FIG. 2B is an enlarged view of the inside of the light source emitting section.

FIGS. 3A and 3B show a structure of a mirror as an optical element according to a first embodiment of the present invention, wherein FIG. 3A is a schematic perspective view of the mirror, and FIG. 3B is a side view of the mirror.

FIG. 4 shows a schematic structure of a cooling apparatus for cooling the mirror shown in FIG. 3.

FIG. 5 is a temperature distribution map of a mirror surface cooled by the cooling apparatus shown in FIG. 4.

FIG. 6 is a flowchart for explaining a device manufacturing method using the exposure apparatus shown in FIG. 1.

FIG. 7 is a detailed flowchart of step 104 in FIG. 6.

FIGS. 8A and 83 show a structure of a mirror as an optical element according to a second embodiment of the present invention, wherein FIG. 8R is a schematic perspective view of the mirror, and FIG. 8B is a side view of the mirror.

FIG. 9 shows a schematic structure of a cooling apparatus for cooling the mirror shown in FIG. 8.

FIG. 10 is a perspective overview showing a structure of a mirror as an optical element according to a third embodiment of the present invention.

FIG. 11 shows a schematic structure of a cooling apparatus for cooling the mirror shown in FIG. 10.

FIG. 12 is a temperature distribution map on the conventional mirror's reflective surface.

FIGS. 13A and 13B show a structure of a mirror as an optical element according to a fourth embodiment of the present invention, wherein FIG. 13A is a schematic perspective view of the mirror, and FIG. 13B is a side view of the mirror.

FIG. 14 is a perspective view of a principal part showing that the coolant circulates through and cools the mirror shown in FIG. 13.

FIGS. 15A and 15B show a structure of a mirror as an optical element according to a fifth embodiment of the present invention, wherein FIG. 15A is a schematic perspective view of the mirror, and FIG. 15B is a side view of the mirror.

FIG. 16 is a perspective view of a principal part showing that the coolant circulates through and cools the mirror shown in FIG. 15.

FIGS. 17A and 173 show a structure of a mirror as an optical element according to another embodiment of the present invention, wherein FIG. 17A is a schematic perspective view of the mirror, and FIG. 17B is a side view of the mirror.

FIGS. 18A and 18B show a structure of a mirror as an optical element according to another embodiment of the present invention, wherein FIG. 18A is a schematic perspective view of the mirror, and FIG. 18B is a side view of the mirror.

FIGS. 19A and 19B show a structure of a mirror as an optical element according to another embodiment of the present invention, wherein FIG. 19A is a schematic perspective view of the mirror, and FIG. 19B is a side view of the mirror.

FIGS. 20A and 20B show a structure of a mirror as an optical element according to still another embodiment of the present invention, wherein FIG. 20A is a schematic perspective view of the mirror, and FIG. 20B is a side view of the mirror.

FIGS. 21A and 21B show a structure of a mirror as an optical element according to still another embodiment of the present invention, wherein FIG. 21A is a schematic perspective view of the mirror, and FIG. 21B is a side view of the mirror.

FIGS. 22A and 22B show a structure of a mirror as an optical element according to still another embodiment of the present invention, wherein FIG. 22A is a schematic perspective view of the mirror, and FIG. 223 is a side view of the mirror.

### DETAILED DESCRIPTION OF THE PREFERRED EMBODIMENTS

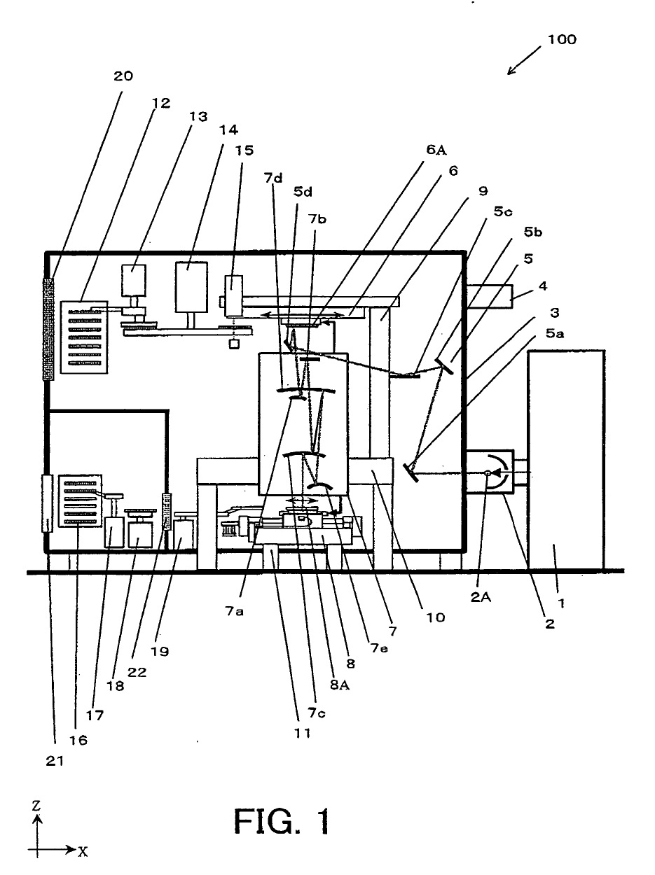

With reference to the accompanying drawings, a description will be given of a mirror as an optical element and its cooling apparatus according one embodiment of the present invention. FIG. 1 shows a schematic internal structure of an exposure apparatus 100 that uses this mirror. This exposure apparatus 100 exposes a pattern on a reticle 6A as an original form onto a wafer 8A as a substrate. The wafer 8A is an object to be exposed, and processed (e.g., etched and cut) after the pattern is exposed. Thereby, a semiconductor device is manufactured from the wafer 8.

In FIG. 1, reference numeral 1 denotes an excitation laser as part of an illumination light source. The excitation laser 1 excites light-source material atoms into plasma for light emissions by irradiating a laser beam onto an emitting point of the light source, at which the light-source material is in a state of gas, liquid or atomized gas. The excitation laser 1 uses a YAG solid laser etc.

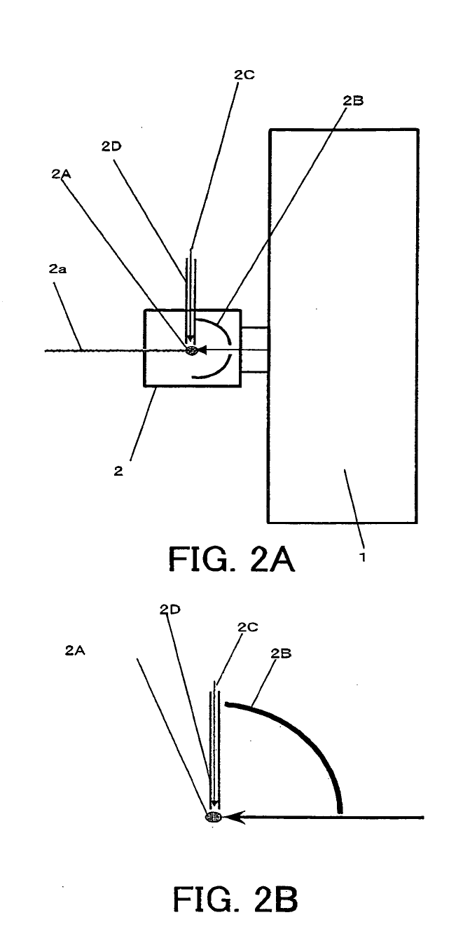

Reference numeral 2 denotes a light-source emitting section as a part of the illumination light source, and is configured to maintain its inside to be vacuum. FIGS. 2A and 2B show the internal structure of the light-source emitting section 2. An emitting point 2A is an actual emitting point of an illumination light source. The illumination light 2a is, for example, the EUV light. A semispherical light source mirror 2B is arranged inside the light-source emitting section 2. In order to condense and reflect the illumination light 2a emitted from the emitting point 2A as spherical light, towards an emitting direction, the light source mirror 2B is arranged at a side opposite to the emitting direction (or at the side of the excitation laser 1 in the figure) so that the emitting point becomes a center of a radius of curvature.

Xenon (Xe) 2C is liquefied and supplied in a form of spray or gas to the light source emitting section 2A. Xe 2C is used as an emitting element, and supplied to the emitting point 2A by the nozzle 2D.

Reference numeral 3 denotes a chamber for accommodating an illumination optical system 5 and a projection optical system 7 in the exposure apparatus 100, which can maintain the vacuum state using a vacuum pump 4.

Reference numeral 5 denotes an illumination optical system for introducing the illumination light 2a from the light-source emitting section 2 to a reticle 6A as an original form held on the reticle stage 6. The illumination optical system 5 includes mirrors 5a to 5d, homogenizes and shapes the illumination light 2a, and introduces the illumination light 2a to the reticle 6A.

A reticle stage 6 holds and moves the reticle 6A, on which a pattern is formed. Since the exposure apparatus 100 is a step-and-scan exposure apparatus, the reticle 6A is mounted on a movable part of the reticle stage 6, moved and scanned in synchronization with the wafer.

Reference numeral 7 denotes a projection optical system for introducing the illumination light 2a that has been irradiated onto the reticle 6A and reflected by the reticle 6A, onto the wafer (or the substrate) 8A as an object to be exposed. The projection optical system 7 includes mirrors 7a to 7e, and introduces the pattern on the reticle 6A to the surface of the wafer 8A by reflecting the pattern via the mirrors 7a to 7e in this order and reduces the pattern by a predefined reduction ratio.

The wafer 8A is a Si substrate, and held on a wafer stage 8. The wafer stage 8 positions the wafer 8A at a predetermined exposure position, and can be driven in six axes directions, i.e., driven in XYZ directions, tilt around the XY axes, and rotated around the Z axis, so as to move the wafer 8A in synchronization with the reticle 6A.

Reference numeral 9 denotes a reticle stage support for supporting the reticle stage 6 on the installation floor of the exposure apparatus 100. Reference numeral 10 denotes a projection optical system body for supporting the projection optical system 7 on the installation floor of the exposure apparatus 100. Reference numeral 11 denotes a wafer stage support for supporting the wafer stage 8 on the installation floor of the exposure apparatus 100.

A position measuring means (not shown) measures positions of the reticle stage 6, the projection optical system 7, and the wafer stage 8, which are distinctly and independently supported by the reticle stage support 9, and a control means (not shown) controls a relative position between the reticle stage 6 and the projection optical system 7, and a relative position between the projection optical system 7 and a wafer stage 8 based on the position measurement results. A mount (not shown) for isolating vibrations from the installation floor of the exposure apparatus 100 is provided on the reticle stage support 9, the projection system body 10, and the wafer stage 11.

Reference numeral 12 denotes a reticle stocker for storing the reticles 6A in the chamber 3 of the exposure apparatus 100. The reticle stocker 12 is an airtight container that stores plural reticle 6A formed in accordance with different patterns and exposure conditions. Reference numeral 13 denotes a reticle changer for selecting and feeding the reticle 6A to be used, from the reticle stocker 12.

Reference numeral 14 denotes a reticle alignment unit that includes a rotatable hand that is movable in the XYZ directions and rotatable around the Z axis. The reticle alignment unit 14 receives the reticle 6A from the reticle changer 13, rotates it by 180°, and feeds it to the field of a reticle alignment scope 15 provided at the end of the reticle stage 6. Then, the reticle 6A is aligned through fine movements of the reticle 6A in the XYZ-axes directions with respect to the alignment mark 15A provided on the basis of the projection optical system 7. The aligned reticle 6A is chucked on the reticle stage 6.

Reference numeral 16 denotes a wafer stocker for storing the wafer 6A in the chamber 3 of the exposure apparatus 100. The wafer stocker 16 stores plural wafers 8A that have not yet been exposed. A wafer feed robot 17 selects a wafer 18A to be exposed, from the wafer stocker 116, and feeds it to a wafer mechanical pre-alignment temperature controller 18.

The wafer mechanical pre-alignment temperature controller 18 roughly adjusts feeding of the wafer 8A in the rotational direction, and controls the wafer temperature within predetermined controlled temperature in the exposure apparatus 100. The inside of the chamber 3 is partitioned by the diaphragm 3a into an exposure space 3A in which the illumination optical system 5 and the projection optical system 7 are installed, and a wafer space 3B in which the wafer stocker 16, the wafer pre-alignment temperature controller 18, and wafer feed hand 19 are installed.

Reference numeral 19 denotes a wafer feed hand. The wafer feed hand 19 feeds the wafer 8A that has been aligned and temperature-controlled by the wafer mechanical pre-alignment temperature controller 18 to the wafer stage 8.

20, 21 and 22 are gate valves. The gate valves 20 and 21 are provided on a wall surface of the chamber 3, and serve as opening/closing mechanisms for supplying the reticle 6A and wafer 8A from the outside of the chamber 3 to the inside of the chamber 3. The gate valve 22 is provided on the diaphragm 3a, and serves as an opening/closing mechanism for opening and closing a gate of the diaphragm 3a when the wafer 8A is fed by the wafer feed hand 19 from the wafer pre-alignment temperature controller 18 to the aligned and temperature-controlled wafer stage 8. Thus, the separation using the diaphragm 3a between the exposure space 3A and the wafer-use space 3B, and opening and closing using the gate 22 can minimize a capacity to be temporarily released to the air, and form a vacuum equilibrium state.

The projection optical system 7 uses a Mo—Si multilayer coating formed on a reflective surface of each of the mirrors 7a to 7e by vacuum evaporation or sputtering. When the illumination light 2a is reflected on each mirror's reflective surface, about 70% of the light is reflected but the remaining about 30% of the light is absorbed in the mirror's base and converted into heat. Without cooling of the mirror, the temperature rises by about 10 to 20° C. in the area that reflects the illumination light 2a (“illumination area”), and the reflective surface deforms by about 50 to 100 nm around the mirror peripheral even when the mirror uses a material having an extremely small coefficient of thermal expansion. As a result, this configuration cannot maintain extremely strict mirror surface shape precisions, e.g., between 0.1 nm to several nanometers, necessary for the projection optical system 7's mirrors, the illumination optical system 5's mirrors, and the light source 2B's mirrors.

In the projection optical system 7, the lowered mirror surface precision deteriorates the imaging performance to the wafer 8A and lowers light intensity. In the illumination optical system 5, the lowered mirror surface precision deteriorates the light intensity to the mask 6A and the uniformity of the light intensity distribution. The light source mirror 2B deteriorates the light intensity due to the bad condensing performance of the illumination light 2a.

The instant embodiment cools the mirror as follows, in order to solve the problems of the heating mirror. Since mirrors' shapes are different depending upon positions, this embodiment describes a cylindrical concave mirror as a representative example. While the instant embodiment regards all the optical elements as mirrors, the sprit of the present invention is applicable to another optical element, such as a lens.

### First Embodiment

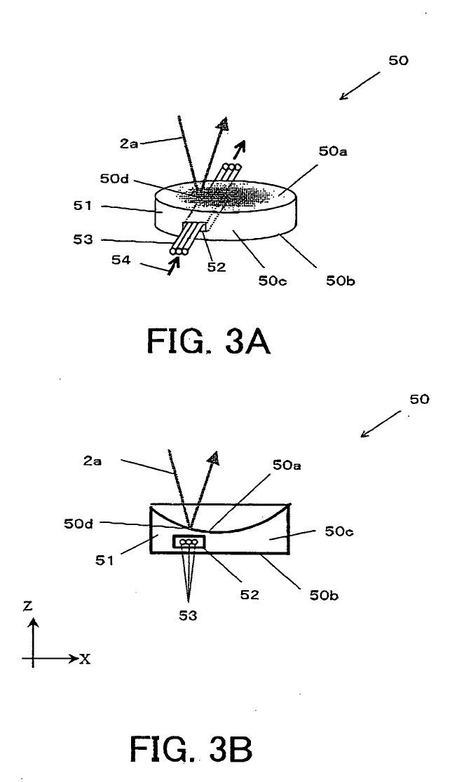

Referring to FIGS. 3 to 5, a description will be given of a mirror and its cooling method according to a first embodiment of the present invention. This mirror 50 is applicable to the light source mirror 2B, the mirrors 5a to 5d of the illumination optical system 5, and the mirrors 7a to 7e of the projection optical system 7. In the first embodiment, the perforation hole 52 is formed in the side surface 50. In other words, when a side surface 50c is defined as a cylindrical peripheral surface that is held between the reflective surface 50a that serves as incident and exit surfaces and reflects the illumination light 2a and the rear surface 50b at the rear side of the reflective surface 50a, an entrance of the perforation hole 52 is formed in the side surface 50c.

The perforation hole 52 is formed so as not to shield the optical path of the illumination light 2a. For example, in the first embodiment, the perforation hole 52 avoids a reflecting point 50d of the illumination light 2a on the reflective surface 50a, and the entrance is formed in the side surface 50c. Therefore, the perforation hole 52 does not affect the optical path of the illumination light 2a.

The cooling pipe 53 perforates the perforation hole 52. Coolant 54 for cooling the mirror 50 circulates through this cooling pipe 53. The coolant 54 may be, for example, cooling water or solution or gas. The cooling pipe 53 does not contact the mirror 50, as shown in FIG. 3B. Therefore, the mirror 50 is not affected by vibrations when the coolant 54 circulates in the cooling pipe 53, and other problems.

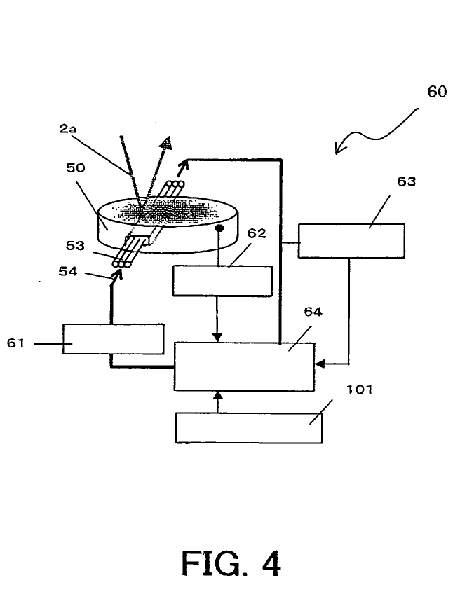

FIG. 4 is a block diagram of a schematic structure of a cooling apparatus for cooling this mirror 50. This cooling apparatus 60 includes the cooling pipe 53, a circulator 61, a mirror thermometer 62 as a first temperature detector, a coolant thermometer 63 as a second temperature detector, and a temperature regulator 64 for controlling the temperature of the coolant 54. The controller 101 of the exposure apparatus 100 is connected to the temperature regulator 64 so that the temperature regulator 64 can receive the exposure control information and the light-intensity control information of the exposure apparatus 100. The circulator 61 and the temperature regulator 64 are connected to the cooling pipe 53.

The circulator 61 serves to circulate the coolant in the cooling pipe 53, and includes, for example, a circulation pump. This circulator 61 may be integrated with the temperature regulator 64, which will be described later. The circulator 61 sequentially supplies the coolant 54 that is temperature-controlled and cooled by the temperature regulator 64, to the cooling pipe 52 in the perforation hole 52 in the mirror 50. The coolant 54 heated by the mirror 50's heat is sequentially fed to the temperature regulator 64. Thereby, the temperature of the mirror 50 can be controlled within a certain range.

The mirror thermometer 62 serves to measure the temperature of the mirror 50. The mirror thermometer 62 may be a contact type or non-contact type. The coolant thermometer 63 serves to measure the temperature of the coolant 54. These thermometers can use any known thermometers, and a detailed description will be omitted.

The temperature regulator 64 serves to regulate the temperature of the coolant 54. In other words, the mirror's temperature measured by the mirror thermometer 62 is compared with the coolant's temperature measured by the coolant thermometer 63, and it is determined whether the mirror's temperature is within a predetermined temperature range, and the temperature of the coolant 54 is regulated in accordance with the determination result. The desired temperature range as a control target is determined by the exposure control information and light intensity control information from the controller 101.

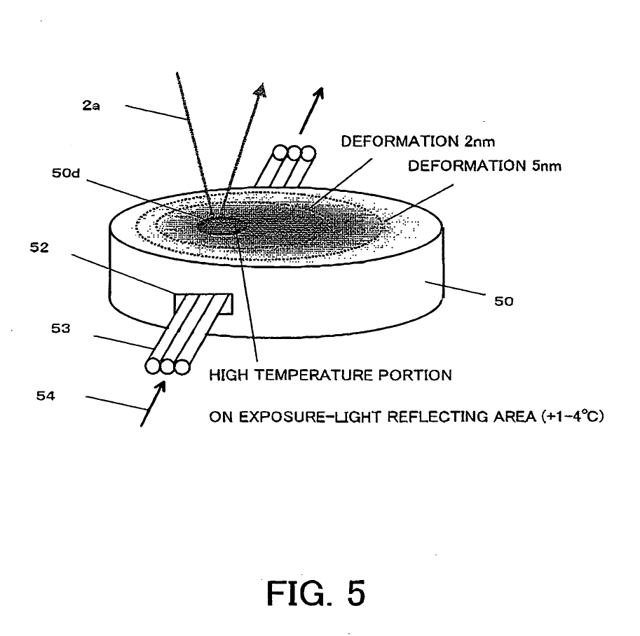

FIG. 5 shows a temperature distribution on the reflective surface 50a when the mirror is cooled by the coolant 54 that is circulated by the circulator 61 in the cooling pipe 53 using the thus structured mirror 50 and cooling apparatus 60. The reflecting point 50d that has the highest exothermic heat in the area illuminated by the illumination light 2a causes the temperature rise by about 10 to 20° C. if there is no cooling apparatus 60. However, when this cooling apparatus 60 is applied to the mirror 50 to cool the mirror 50, the temperature rise at the reflective point 50d is reduced down to about 1 to 4° C., as shown in FIG. 5. Therefore, the deformation amount on the mirror's reflective surface 50a is reduced below 2 nm due to the temperature rise at the reflecting point 50d.

As shown in FIG. 3B, it is preferable that the perforation hole 52 is formed below and near the reflecting point 50d in the mirror 50 without negatively affecting the reflective surface 50a. In other words, radiation cooling of the mirror 50 from the cooling pipe 53 improves its cooling efficiency when a distance from the cooling pipe 53 to the reflecting point 50d is as small as possible. Since the optical element is the mirror 50In the first embodiment, the perforation hole 52 formed below and near the reflecting point 50d does not shield the optical path of the illumination light 2a. However, when the optical element is a lens, the illumination light 2a transmits through the lens and thus the perforation hole should be formed to avoid an incident area on an incident surface of the illumination light 2a, a light transmission area of the illumination light 2a that transmits the lens' base, and an exit area on an exit surface of the illumination light 2a. As long as the perforation hole is thus formed, the present invention is applicable to the lens.

The first embodiment uses the cooling pipe 53 for cooling of the mirror 50, but may use a radiation plate (not shown) instead of the cooling plate. In this case, the perforation hole 52 is formed in the radiation plate to be cooled by the coolant 54. The coolant 54 may be pass the perforation hole 52 with the radiation plate or may contact and cool the radiation plate at part other than the perforation hole 52. Even when the coolant 54 does not pass the perforation hole, the radiation cools the radiation plate in the perforation hole 52 and consequently cools the mirror 50.

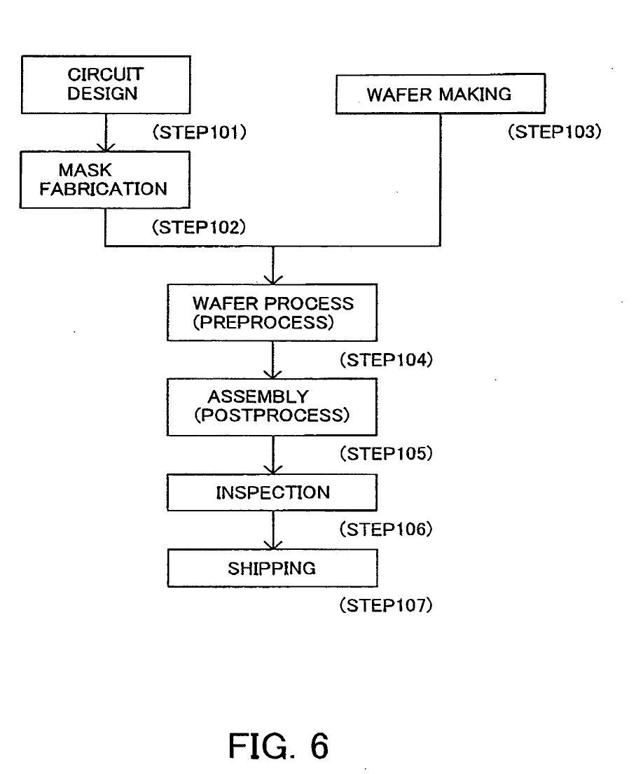

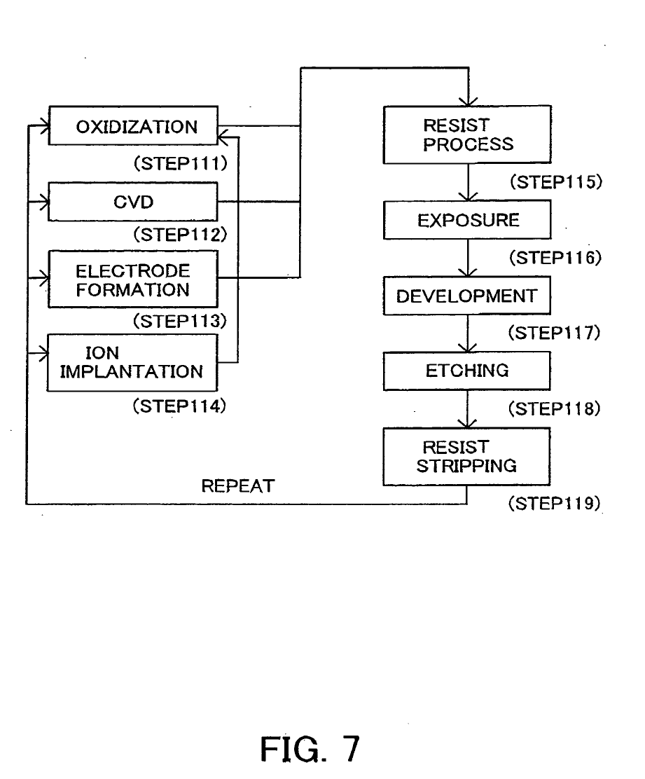

Referring to FIGS. 6 and 7, a description will now be given of an embodiment of a device fabricating method using the above mentioned exposure apparatus 100. FIG. 6 is a flowchart for explaining a fabrication of devices (i.e., semiconductor chips such as IC and LSI, LCDs, CCDs, etc.). Here, a description will be given of a fabrication of a semiconductor chip as an example. Step 101 (circuit design) designs a semiconductor device circuit. Step 102 (mask fabrication) forms a mask having a designed circuit pattern. Step 103 (wafer making) manufactures a wafer using materials such as silicon. Step 104 (wafer process), which is referred to as a pretreatment, forms actual circuitry on the wafer through photolithography using the mask and wafer. Step 105 (assembly), which is also referred to as a post-treatment, forms into a semiconductor chip the wafer formed in Step 104 and includes an assembly step (e.g., dicing, bonding), a packaging step (chip sealing), and the like. Step 106 (inspection) performs various tests for the semiconductor device made in Step 5, such as a validity test and a durability test. Through these steps, a semiconductor device is finished and shipped (Step 107).

FIG. 7 is a detailed flowchart of the wafer process in Step 104 shown in FIG. 6. Step 111 (oxidation) oxidizes the wafer's surface. Step 112 (CVD) forms an insulating film on the wafer's surface. Step 113 (electrode formation) forms electrodes on the wafer by vapor disposition and the like. Step 114 (ion implantation) implants ion into the wafer. Step 115 (resist process) applies a photosensitive material onto the wafer. Step 116 (exposure) uses the exposure apparatus 100 to expose a circuit pattern on the mask onto the wafer. Step 117 (development) develops the exposed wafer. Step 18 (etching) etches parts other than a developed resist image. Step 119 (resist stripping) removes disused resist after etching. These steps are repeated, and multilayer circuit patterns are formed on the wafer. The device fabrication method of this embodiment may manufacture higher quality devices than the conventional one.

### Second Embodiment

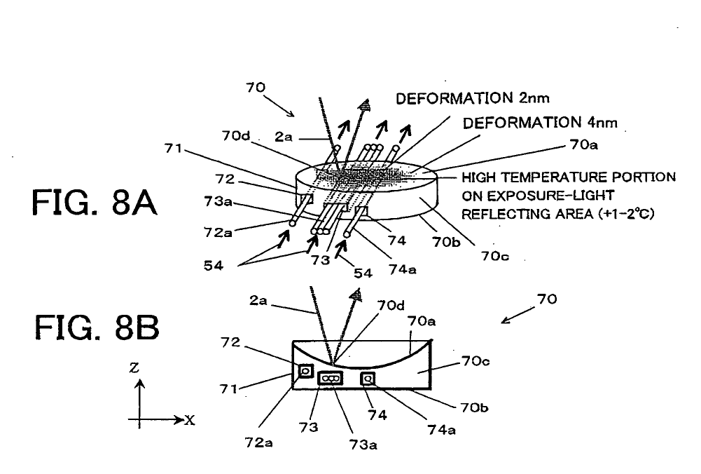

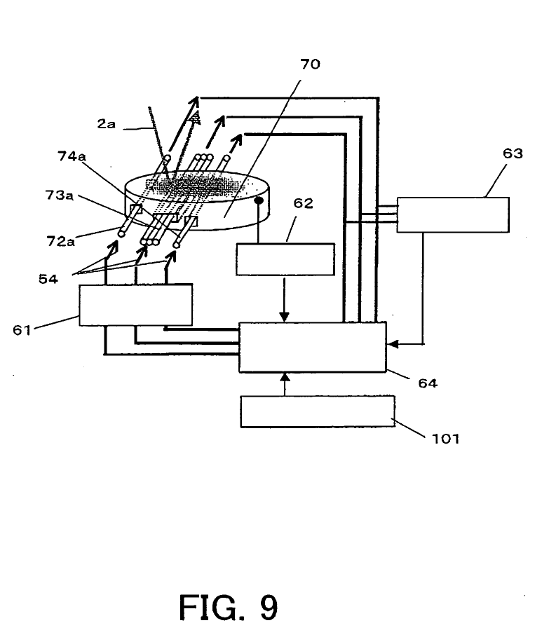

Referring to FIGS. 8 and 9, a description will be given of a mirror as an optical element and its cooling method according to a second embodiment of the present invention. Those elements which are corresponding elements in the first embodiment are designated by the same reference numerals, and a description will be omitted.

Similar to the mirror 50, the mirror 70 is applicable to the light source mirror 2B, the mirrors 5a to 5d of the illumination optical system 5, and the mirrors 7a to 7e of the projection optical system 7. Plural perforation holes 72, 73 and 74 are formed in a base 71 of this mirror 70. In this second embodiment, the perforation holes 72 to 74 are formed in a side surface 70c. In other words, when a side surface 70c is defined as a cylindrical peripheral surface that is held between the reflective surface 70a that serves as incident and exit surfaces and reflects the illumination light 2a and the rear surface 50b at the rear side of the reflective surface 50a, entrances of the perforation holes 72 to 74 are formed in the side surface 70c.

The perforation holes 72 to 74 are formed so as not to shield the optical path of the illumination light 2a. For example, in the second embodiment, the perforation hole 72 avoids a reflecting point 70d of the illumination light 2a on the reflective surface 70a, and its entrance is formed in the side surface 70c. Therefore, the perforation holes 72 to 74 do not affect the optical path of the illumination light 2a The perforation hole 730 is formed, as shown in FIG. 8B, below and near the reflecting point 70d in a range that does not negatively affect the reflective surface 70a. The perforation holes 72 and 74 are formed near and adjacent to the perforation hole 73 at left and right sides of the perforation holes 73. While the second embodiment exemplarily discusses three perforation holes 72 to 74, the number of perforation holes may increase or decrease if necessary or based on various parameters and cooling and other necessary performances.

Cooling pipes 72a to 74a perforate the perforation holes 72 to 74. Coolant 54 for cooling the mirror 70 circulates through each of these cooling pipes 72a to 74a. The coolant 54 may be, for example, cooling water or solution or gas. The cooling pipes 72a to 74a do not contact the mirror 70, as shown in FIG. 8B. Therefore, the mirror 70 is not affected by vibrations when the coolant 54 circulates in these cooling pipes 72a to 74a, and other problems.

FIG. 9 is a block diagram of a schematic structure of a cooling apparatus for cooling this mirror 70. This cooling apparatus 60 includes the cooling pipes 72a to 74a, a circulator 61, a mirror thermometer 62 as a first temperature detector, a coolant thermometer 63 as a second temperature detector, and a temperature regulator 64 for controlling the temperature of the coolant 54. The controller 101 of the exposure apparatus 100 is connected to the temperature regulator 64 so that the temperature regulator 64 can receive the exposure control information and the light-intensity control information of the exposure apparatus 100. The circulator 61 and the temperature regulator 64 are connected to plural cooling pipes 72a to 74a, and the coolant thermometer 63 measures the temperature of the coolant 54 that circulates in these cooling pipes 72a to 74a. Other structures and functions are similar to those in the first embodiment.

When the mirror 70 is cooled by the coolant 54 that is circulated by the circulator 61 in the cooling pipes 72a to 74a using the thus structured mirror 70 and cooling apparatus 60, the mirror 70 is more efficiently cooled than the first embodiment. For example, the temperature rise at the reflective point 70d is reduced down to about 1 to 2° C.

In the second embodiment, radiation cooling of the mirror 70 from the cooling pipes 72a to 74a improves its cooling efficiency when a distance from the cooling pipe 53 to the reflecting point 70d is as small as possible.

### Third Embodiment

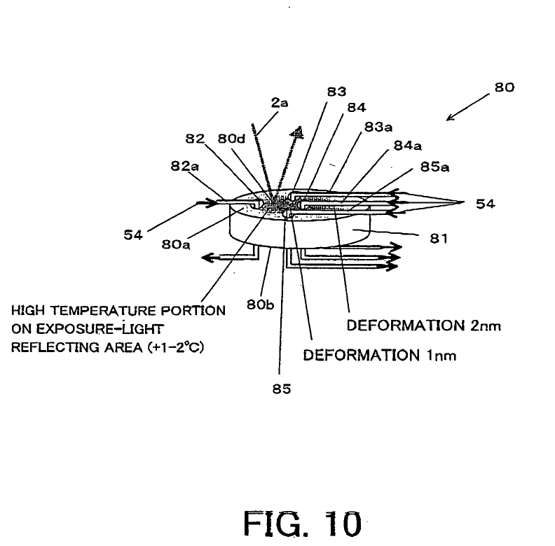

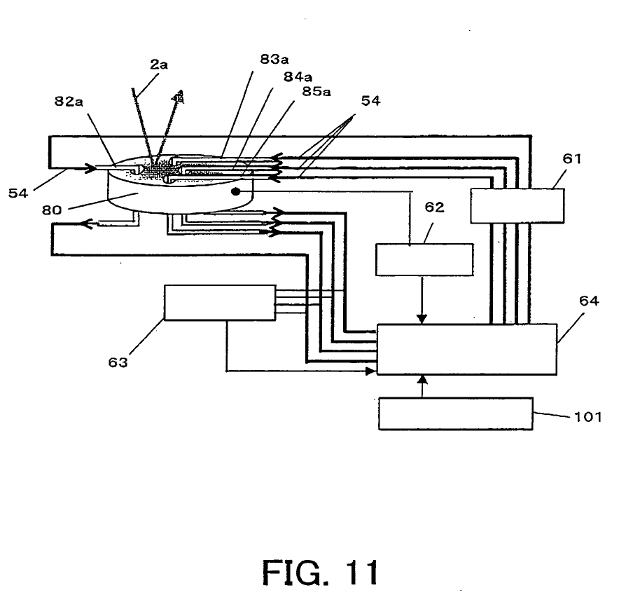

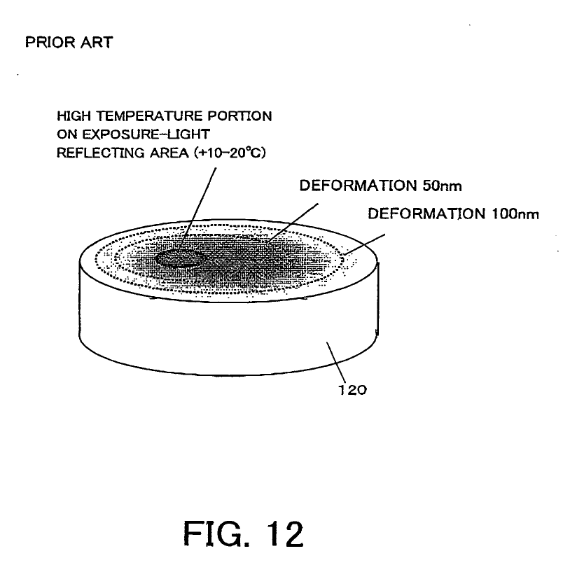

Referring to FIGS. 10 and 11, a description will be given of a mirror as an optical element and its cooling method according to a third embodiment of the present invention. Those elements which are corresponding elements in the first embodiment are designated by the same reference numerals, and a description will be omitted.

Similar to the mirror 50, the mirror 80 is applicable to the light source mirror 2B, the mirrors 5a to 5d of the illumination optical system 5, and the mirrors 7a to 7e of the projection optical system 7. Plural perforation holes 82, 83, 84 and 85 are formed in a base 81 of this mirror 80. In this third embodiment, the perforation holes 82 to 85 perforate this mirror 80 from the reflective surface 80a to the rear surface 80b, and entrances of the perforation holes 82 to 85 are formed in the reflective surface 80a and the rear surface 80b.

As shown in FIG. 10, the entrances of the perforation holes 82 to 85 are formed so as not to shield the optical path of the illumination light 2a. The perforation hole 82 avoids a reflecting point 80d of the illumination light 2a on the reflective surface 80a, and is formed near and around the reflective surface 80d. Therefore, formations of the perforation holes 82 to 84 do not affect the optical path of the illumination light 2a. While the third embodiment exemplarily discusses four perforation holes 82 to 85, the number of perforation holes may increase or decrease if necessary or based on various parameters and cooling and other necessary performances.

Cooling pipes 82a to 85a perforate the perforation holes 82 to 85. Coolant 54 for cooling the mirror 80 circulates through each of these cooling pipes 82a to 85a. The coolant 54 may be, for example, cooling water or solution or gas. The cooling pipes 82a to 85a do not contact the mirror 80, and thus the mirror 80 is not affected by vibrations when the coolant 54 circulates in these cooling pipes 82a to 85a, and other problems.

FIG. 11 is a block diagram of a schematic structure of a cooling apparatus for cooling this mirror 80. This cooling apparatus 60 includes the cooling pipes 82a to 85a, a circulator 61, a mirror thermometer 62 as a first temperature detector, a coolant thermometer 63 as a second temperature detector, and a temperature regulator 64 for controlling the temperature of the coolant 54. The controller 101 of the exposure apparatus 100 is connected to the temperature regulator 64 so that the temperature regulator 64 can receive the exposure control information and the light-intensity control information of the exposure apparatus 100. The circulator 61 and the temperature regulator 64 are connected to plural cooling pipes 82a to 85a, and the coolant thermometer 63 measures the temperature of the coolant 54 that circulates in these cooling pipes 82a to 85a. Other structures and functions are similar to those in the first embodiment.

When the mirror 80 is cooled by the coolant 54 that is circulated by the circulator 61 in the cooling pipes 82a to 85a using the thus structured mirror 80 and cooling apparatus 60, the mirror 80 is more efficiently cooled than the first embodiment. For example, the temperature rise at the reflective point 80d is reduced down to about 1 to 2° C.

In the third embodiment, radiation cooling of the mirror 80 from the cooling pipes 82a to 85a improves its cooling efficiency when a distance from the cooling pipe 53 to the reflecting point 80d is as small as possible.

### Fourth Embodiment

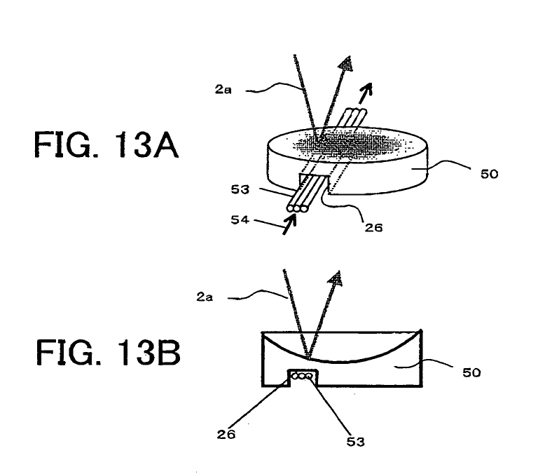

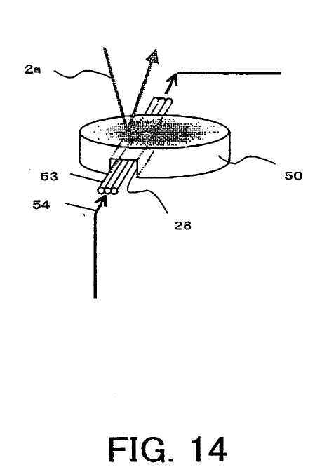

Referring to FIGS. 13 and 14, a description will be given of the mirror 50 as an optical element and its cooling method according to a fourth embodiment of the present invention. In this fourth embodiment, a groove-shaped notch 26 is provided as a non-perforation hole or a convexo-concave groove, as shown in FIG. 13, on a mirror's base near the reflecting portion of the illumination light 2a in the mirrors 7a to 7e of the projection optical system 7 and the mirrors 5a to 5d of the illumination optical system 5. This notch 26 is formed from a side surface to side surface of the mirror 50. The cooling pipe 53 for circulating the coolant 54 is provided on the groove portion of this notch 26 so that the cooling pipe 53 does not contact the mirror's base.

Similar to the first embodiment, the temperature distribution on the mirror surface is as shown in FIG. 5 when the coolant 54 flows in the cooling pipe 53. The reflecting point 50d that has the highest exothermic heat in the area illuminated by the illumination light 2a causes the temperature rise by about 10 to 20° C. if there is no cooling apparatus 60. However, when the mirror 50 is cooled according to the fourth embodiment, the temperature rise at the reflective point 50d is reduced down to about 1 to 4° C., as shown in FIG. 5. Therefore, the deformation amount on the mirror's reflective surface 50a is reduced below 2 nm due to the temperature rise at the reflecting point 50d.

The temperature control of the coolant 54 in the fourth embodiment is similar to a method of the first embodiment. In other words, the cooling apparatus 60 shown in FIG. 4 is applied to the mirror 50 shown in FIG. 14, and the coolant 54 is circulated in the cooling pipe 53. The coolant 54 that is temperature-controlled to a target temperature by the temperature regulator 64 circulates the cooling pipe 53 and passes the groove portion on the notch 26 provided on the base of the mirror 50. Since the cooling pipe 53 does not contact the base of the mirror 50, the mirror 50 is radiation-cooled by a temperature difference between them.

### Fifth Embodiment

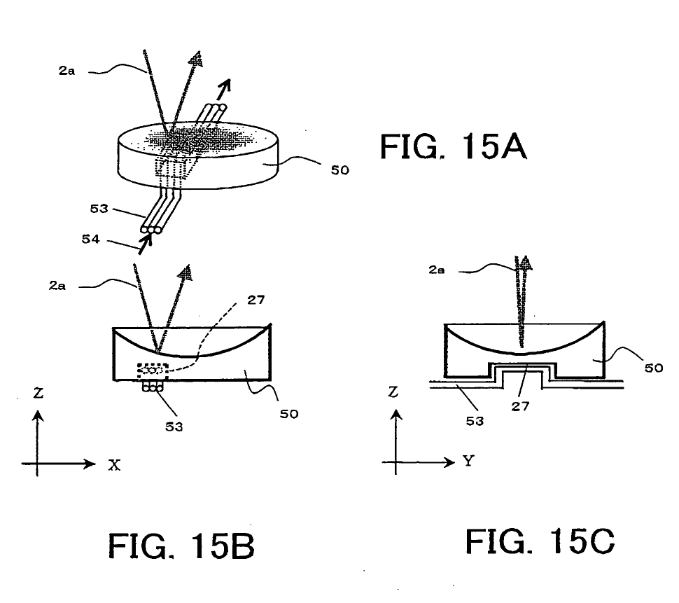

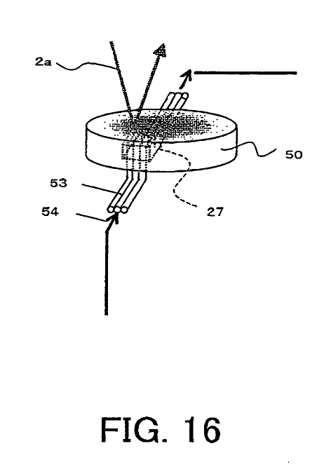

Referring to FIGS. 15 and 16, a description will be given of the mirror 50 as an optical element and its cooling method according to a fifth embodiment of the present invention. In this fifth embodiment, a partially groove-shaped notch 27 is provided, as shown in FIG. 15, on a mirror's base near the reflecting portion of the illumination light 2a in the mirrors 7a to 7e of the projection optical system 7 and the mirrors 5a to 5d of the illumination optical system 5. This notch 27 is partially formed on a bottom surface below and near the reflection portion of the illumination light 2a in the mirror 50. The cooling pipe 53 for circulating the coolant 54 is provided on the groove portion of this notch 27 so that the cooling pipe 53 does not contact the mirror's base.

Similar to the first embodiment, the temperature distribution on the mirror surface is as shown in FIG. 5 when the coolant 54 flows in the cooling pipe 53. The reflecting point 50d that has the highest exothermic heat in the area illuminated by the illumination light 2a causes the temperature rise by about 10 to 20° C. if there is no cooling apparatus 60. However, when the mirror 50 is cooled according to the fifth embodiment, the temperature rise at the reflective point 50d is reduced down to about 1 to 4° C., as shown in FIG. 5. Therefore, the deformation amount on the mirror's reflective surface 50a is reduced below 2 nm due to the temperature rise at the reflecting point 50d.

The temperature control of the coolant 54 in the fifth embodiment is similar to a method of the first embodiment. In other words, the cooling apparatus 60 shown in FIG. 4 is applied to the mirror 50 shown in FIG. 16, and the coolant 54 is circulated in the cooling pipe 53. The coolant 54 that is temperature-controlled to a target temperature by the temperature regulator 64 circulates the cooling pipe 53 and passes the groove portion on the notch 26 provided on the base of the mirror 50. Since the cooling pipe 53 does not contact the base of the mirror 50, the mirror 50 is radiation-cooled by a temperature difference between them.

### Another Embodiment

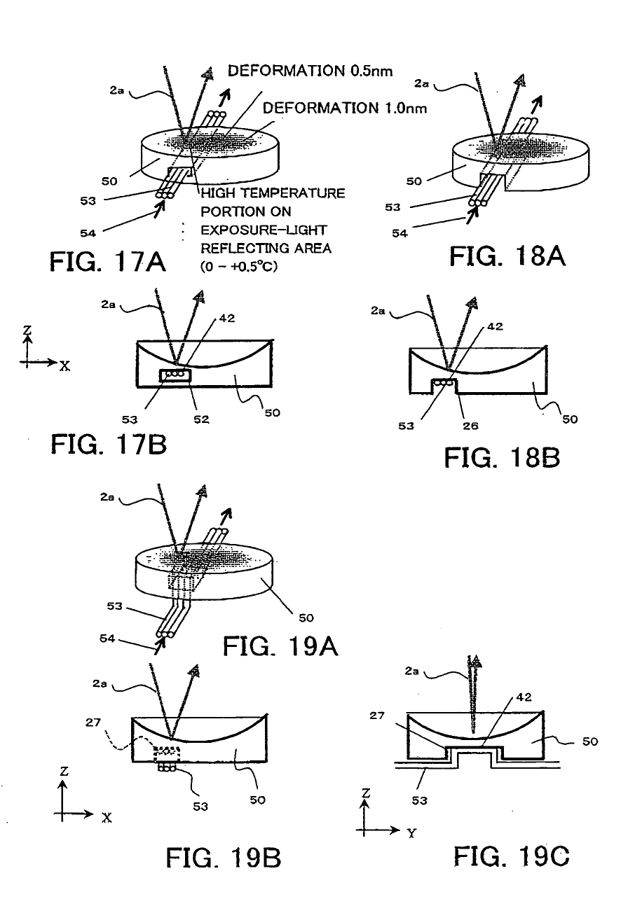

Referring to FIGS. 17 to 19, a description will be given of another embodiment according to the present invention. In FIG. 17, the perforation hole 52 similar to that shown in FIG. 3 is formed in the mirror 50. In FIG. 18, the groove-shaped notch 26 similar to that shown in FIG. 13 is formed on the mirror 50. In FIG. 19, the partially groove-shaped notch 27 similar to that shown in FIG. 15 is formed on the mirror 50.

In FIGS. 17 to 19, the cooling pipe 53 passes and contacts the mirror 50's base on a contact surface 42 for the perforation hole 52 and the notches 26 and 27. Thereby, the cooling efficiency improves higher than that of FIGS. 3, 13 and 15 in which the cooling pipe 53 does not contact the mirror 50's base. Therefore, the embodiment shown in FIGS. 17 to 19 can maintain the temperature rise by about 0 to 0.5° C. near the reflecting point of the illumination light 2a on the reflective surface, which corresponds to a high temperature portion in an exposure light reflecting area in FIG. 5.

The temperature control of the coolant 54 in this embodiment is similar to a method of the first embodiment. In mounting the cooling pipe 53 of the contact state, the distortion of the cooling pipe 53 more easily affects the mirror 50 than the non-contact state. Therefore, an elastic member (not shown) etc. is preferably to be used especially to support the cooling pipe 53 so that no deformation transmits the mirror 50.

### Still Another Embodiment

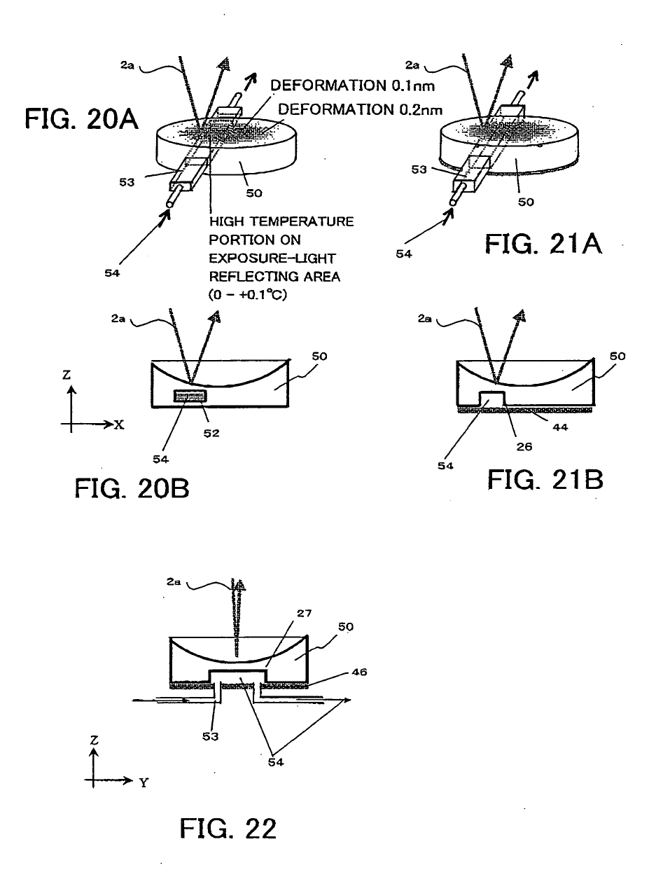

Referring to FIGS. 20 to 22, a description will be given of still another embodiment according to the present invention. In FIG. 20, the perforation hole 52 similar to that shown in FIG. 3 is formed in the mirror 50. In FIG. 18, the groove-shaped notch 26 similar to that shown in FIG. 13 is formed on the mirror 50. In FIG. 19, the partially groove-shaped notch 27 similar to that shown in FIG. 15 is formed on the mirror 50.

This embodiment directly circulates the coolant 54 in the perforation hole 52 and the groove portions of the notches 26 and 27, instead of providing the cooling pipe in the perforation hole or notch in the mirror's base. Therefore, the coolant 54 directly contacts the base of the mirror 50. The notches 26 and 27 shown in FIGS. 21 and 22 seal the bottom surface of the mirror 50 using the covers 44 and 46 so that the coolant 54 does not leak.

Thereby, the cooling efficiency improves higher than the embodiment shown in FIGS. 3, 13 and 15 in which the cooling pipe 53 does not contact the mirror 50's base and the above other embodiment. Therefore, the embodiment shown in FIGS. 20 to 22 can maintain the temperature rise by about 0 to 0.1° C. near the reflecting point of the illumination light 2a on the reflective surface, which corresponds to a high temperature portion in an exposure light reflecting area in FIG. 5. The temperature control of the coolant 54 in this embodiment is similar to a method of the first embodiment.

The present invention efficiently and definitely cools an optical element used for an exposure apparatus without lowering the exposure precision, such as vibrations associated with coolant circulations Thereby, a surface precision of the optical element improves, and the exposure precision and throughput also improve by maintaining the light intensity, the light intensity uniformity, and condensing performance. Ultimately, the present invention improves the qualities of the objects exposed by this exposure apparatus and devices manufactured from this exposed objects.

Further, the present invention is not limited to these preferred embodiments, and various variations and modifications may be made without departing from the scope of the present invention.

This application claims a foreign priority based on Japanese Patent Application No. 2003-412776, filed Dec. 11, 2003, which is hereby incorporated by reference herein.

1. An exposure apparatus for projecting a pattern of an original onto a substrate using illumination light, said exposure apparatus comprising:
a transfer system, having a channel, to transfer heat via said channel; and
an optical element, upon which the illumination light enters, and in which a space, in which said channel is provided, is formed.

2. An exposure apparatus according to claim 1, wherein the space comprises at least one of a through-hole and a concave portion.

3. An exposure apparatus according to claim 1, wherein said space and said channel are located outside a region through which the illumination light passes.

4. An exposure apparatus according to claim 1, wherein said channel is spaced from said optical element in said space.

5. An exposure apparatus according to claim 1, wherein said transfer system transfers a temperature-controlled medium through said channel.

6. An exposure apparatus according to claim 1, wherein said transfer system comprises a radiation plate provided in said space.

7. An exposure apparatus according to claim 1, wherein said space is located at a first surface, upon which the illumination light enters, of said optical element

8. An exposure apparatus according to claim 7, wherein the space is located at a second surface opposite to the first surface.

9. An exposure apparatus according to claim 1, wherein the space is located at a surface opposite to a surface, upon which the illumination light enters, of said optical element.

10. An exposure apparatus according to claim 1, wherein the space is located at a side surface of said optical element.

11. An exposure apparatus according to claim 1, wherein said optical element is one of a mirror and a lens.

12. An exposure apparatus according to claim 1, further comprising a vacuum system for creating a vacuum atmosphere in which said optical element is located.

13. An exposure apparatus according to claim 1, further comprising a light source for emitting EUV light as the illumination light.

14. An exposure apparatus according to claim 1, wherein said optical element is an element of one of an optical system to direct the light from a light source to the original, and an optical system to direct the light from the original to the substrate.

15. An exposure apparatus according to claim 1, wherein said transfer system comprises a tube which passes through said space, and a circulation system to circulate temperature controlled medium via said tube.

16. An exposure apparatus according to claim 15, wherein said transfer system comprises:
a first temperature detecting unit to detect temperature of said optical element;
a second temperature detecting unit to detect temperature of the medium; and
a temperature control unit to control temperature of the medium based on detection results by said first and second temperature detecting units.

17. A device manufacturing method comprising steps of:
transferring a pattern of an original to a substrate using an exposure apparatus as recited in claim 1; and
developing the substrate to which the pattern has been transferred.
